(19) United States
(12) Patent Application Publication
(10) Pub. No.: US 2025/0283487 A1
(43) Pub. Date: Sep. 11, 2025

(54) ABNORMALITY DIAGNOSIS SYSTEM

(71) Applicant: TOYOTA JIDOSHA KABUSHIKI KAISHA, Toyota-shi (JP)

(72) Inventors: Hideaki BUNAZAWA, Nagoya-shi (JP); Mashu YAMAMOTO, Takahama-shi (JP); Kunio SUZUKI, Tokyo (JP); Takuya SHINTATE, Tokyo (JP)

(21) Appl. No.: 19/063,366

(22) Filed: Feb. 26, 2025

(30) Foreign Application Priority Data
Mar. 8, 2024 (JP) 2024-035846

(51) Int. Cl. F15B 19/00

(52) U.S. Cl. CPC F15B 19/00; F15B 2211/857

(57) ABSTRACT

An abnormality diagnosis system includes a storage and processing circuitry. The storage stores reference cluster data that is obtained by classifying, into a predetermined number of clusters, data points on differential pressure obtained when a hydraulic pressure control device in which an abnormality has not occurred is operated. The processing circuitry generates, as evaluation data, data points indicating changes in differential pressure of a hydraulic pressure control device to be evaluated. The processing circuitry generates evaluation cluster data obtained by determining which of clusters in reference cluster data each data point in the evaluation data belongs to by comparing the data points on differential pressure included in the evaluation data with a centroid of each of the clusters in the reference cluster data. The processing circuitry determines that an abnormality has occurred in the hydraulic pressure control device based on a deviation between the determination results of the clusters.

### CROSS-REFERENCE TO RELATED APPLICATIONS

This application is based upon and claims the benefit of priority from Japanese Patent Application No. 2024-035846, filed on Mar. 8, 2024, the entire contents of which are incorporated herein by reference.

### BACKGROUND

### 1. Field

The present disclosure relates to an abnormality diagnosis system for a hydraulic pressure control device.

### 2. Description of Related Art

Japanese Laid-Open Patent Publication No. 2021-085480 discloses an abnormality diagnosis system for identifying the cause of an abnormality in shift control of an automatic transmission. The abnormality diagnosis system determines the cause of the abnormality in the automatic transmission based on the aspects of transient changes in a rotational speed of the automatic transmission.

In a case where the determination is performed by observing the fluctuation of the rotational speed in the automatic transmission, there is a possibility that the cause of the abnormality cannot be identified. For example, it is difficult to determine a failure of a component in the hydraulic pressure control device of the automatic transmission from the fluctuation of the rotational speed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An abnormality diagnosis system according to an aspect of the present disclosure includes processing circuitry and a storage. The storage of the abnormality diagnosis system stores reference cluster data. The reference cluster data is obtained by classifying, into a predetermined number of clusters by clustering, data points on differential pressure at multiple time points included in data on changes in differential pressure between a target hydraulic pressure and a hydraulic pressure that is obtained when a hydraulic pressure control device in which an abnormality has not occurred is operated in a predetermined diagnosis pattern. The clustering is machine learning. The processing circuitry of the abnormality diagnosis system is configured to generate, as evaluation data, data indicating changes in differential pressure between the target hydraulic pressure and a hydraulic pressure that is recorded while operating the hydraulic pressure control device to be evaluated in the diagnosis pattern. The processing circuitry is configured to generate evaluation cluster data obtained by determining which of the predetermined number of clusters in the reference cluster data each of data points at multiple time points in the evaluation data belongs to by comparing data points on differential pressure at multiple time points included in the evaluation data with a centroid of each of the clusters in the reference cluster data. The processing circuitry is configured to determine that an abnormality has occurred in the hydraulic pressure control device based on a deviation of a determination result of the clusters between the reference cluster data and the evaluation cluster data.

The abnormality diagnosis system performs a determination using the data on the fluctuation of the hydraulic pressure of the hydraulic pressure control device. This allows the abnormality diagnosis system to acquire changes in the behavior of a hydraulic pressure resulting from an abnormality and determine that an abnormality has occurred in the hydraulic pressure control device.

Other features and aspects will be apparent from the following detailed description, the drawings, and the claims.

### BRIEF DESCRIPTION OF THE DRAWINGS

FIG. 1 is a schematic diagram showing an embodiment of an abnormality diagnosis system and a hydraulic pressure control device to be diagnosed.

FIG. 2 is a schematic diagram showing a configuration of the hydraulic pressure control device.

FIG. 3 is a graph showing an example of a diagnosis pattern.

FIG. 4 is a graph showing an example of clustering.

FIG. 5 is a flowchart showing the flow of processes executed by the abnormality diagnosis system.

FIG. 6 is a table showing the result of clustering.

FIG. 7 is a table showing the relationship between the clustering result and the type of abnormality.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

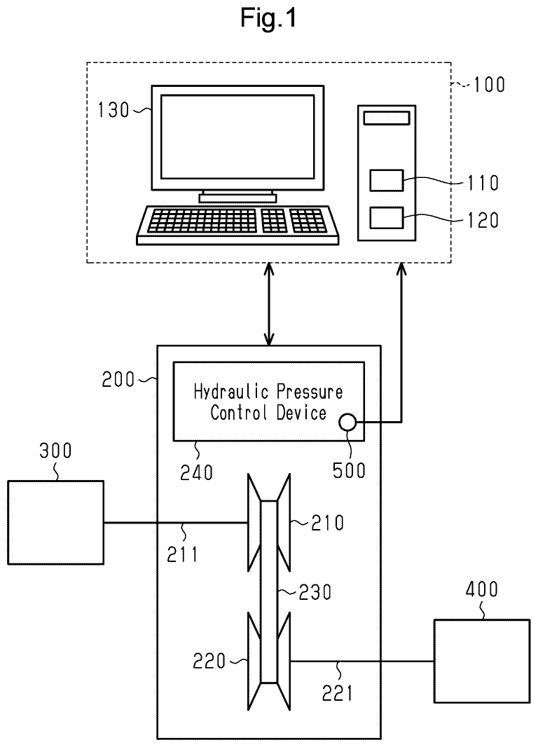

Hereinafter, an embodiment of the abnormality diagnosis system 100 will be described with reference to FIGS. 1 to 7.

### Configuration of Abnormality Diagnosis System 100

FIG. 1 shows the abnormality diagnosis system 100 and an automatic transmission 200 including a hydraulic pressure control device 240 to be diagnosed. When diagnosing the hydraulic pressure control device 240, as shown in FIG. 1, the abnormality diagnosis system 100 is connected to the automatic transmission 200. The abnormality diagnosis system 100 diagnoses the hydraulic pressure control device 240 by operating the hydraulic pressure control device 240 in a predetermined diagnosis pattern.

As shown in FIG. 1, the abnormality diagnosis system 100 includes processing circuitry 110, a storage 120, and a display 130. The processing circuitry 110 includes a CPU that executes processing in accordance with a program, and a ROM in which the program is stored. The storage 120 stores data. The abnormality diagnosis system 100 is, for example, a personal computer or a workstation.

### Configuration of Automatic Transmission 200

The automatic transmission 200 including the hydraulic pressure control device 240 to be inspected is mounted on, for example, an automobile. In FIG. 1, a continuously variable transmission is shown as an example of the automatic transmission 200. The automatic transmission 200 includes a first pulley 210, a second pulley 220, and a belt 230 wound around the first pulley 210 and the second pulley 220. The first pulley 210 is connected to an input shaft 211. The second pulley 220 is connected to an output shaft 221. The automatic transmission 200 transmits a driving force via a belt 230. In the automatic transmission 200, the hydraulic pressure control device 240 controls a first hydraulic pressure Pp supplied to the first pulley 210 and a second hydraulic pressure Ps supplied to the second pulley 220. Accordingly, the winding radius of the belt 230 on each of the first pulley 210 and the second pulley 220 changes. That is, the hydraulic pressure control device 240 changes the gear ratio of the automatic transmission 200 by changing the winding radius of the belt 230.

When diagnosing the hydraulic pressure control device 240, a drive motor 300 is connected to the input shaft 211, and a load motor 400 is connected to the output shaft 221. Hydraulic pressure sensors 500 that detect the hydraulic pressure of each part are connected to the hydraulic pressure control device 240. The diagnosis of the hydraulic pressure control device 240 is performed, for example, as a pre-shipment inspection after the automatic transmission 200 is manufactured. The drive motor 300 reproduces an input of the driving force to the automatic transmission 200 from a driving power source for an automobile. The load motor 400 reproduces a load acting on the automatic transmission 200.

### Configuration of Hydraulic Pressure Control Device 240

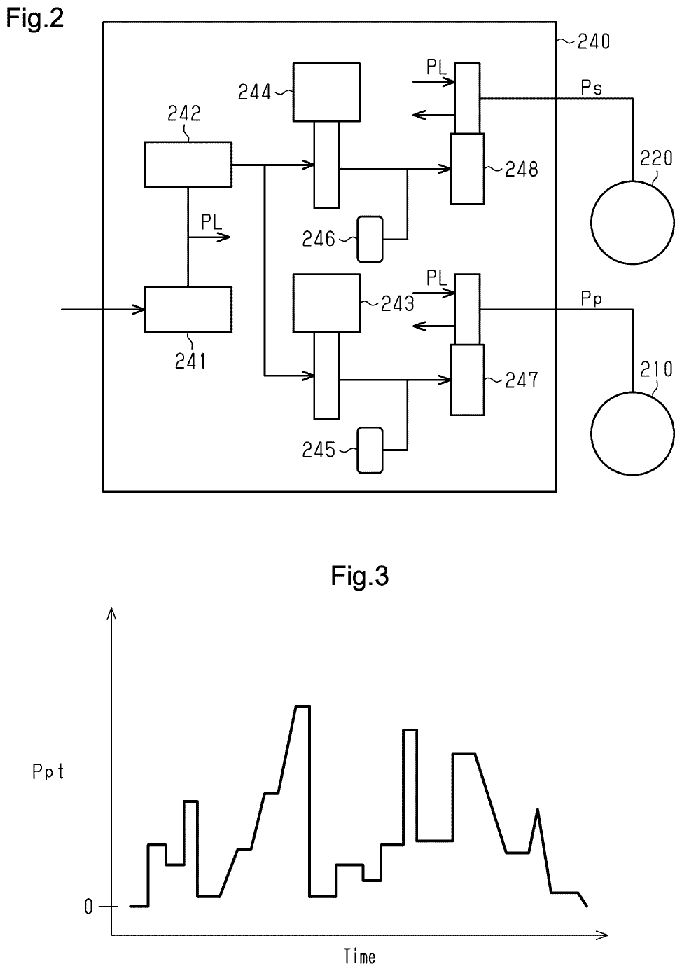

As shown in FIG. 2, the hydraulic pressure control device 240 includes a regulator valve 241, a modulator valve 242, a first control valve 247, and a second control valve 248. The hydraulic pressure control device 240 includes a first linear solenoid valve 243, a second linear solenoid valve 244, a first hydraulic damper 245, and a second hydraulic damper 246.

The regulator valve 241 regulates the hydraulic pressure of the oil supplied from the oil pump. The hydraulic pressure regulated by the regulator valve 241 is a line pressure PL. The oil regulated to the line pressure PL is supplied to the first control valve 247 and the second control valve 248. The hydraulic pressure adjusted to the line pressure PL is also supplied to the modulator valve 242.

The first control valve 247 supplies the oil regulated to the line pressure PL to the first pulley 210. The first control valve 247 controls the amount of oil supplied to the first pulley 210. The first control valve 247 increases the first hydraulic pressure Pp by supplying the oil regulated to the line pressure PL to the first pulley 210. The first control valve 247 controls the amount of oil discharged from the first pulley 210. The first control valve 247 lowers the first hydraulic pressure Pp by discharging oil from the first pulley 210.

The second control valve 248 supplies the oil regulated to the line pressure PL to the second pulley 220. The second control valve 248 controls the amount of oil to be supplied to the second pulley 220. The second control valve 248 increases the second hydraulic pressure Ps by supplying the oil regulated to the line pressure PL to the second pulley 220. The second control valve 248 also controls the amount of oil discharged from the second pulley 220. The second control valve 248 lowers the second hydraulic pressure Ps by discharging oil from the second pulley 220.

When the first hydraulic pressure Pp is increased and the second hydraulic pressure Ps is decreased, the winding radius of the belt 230 around the first pulley 210 increases and the winding radius of the belt 230 around the second pulley 220 decreases. When the second hydraulic pressure Ps is increased and the first hydraulic pressure Pp is decreased, the winding radius of the belt 230 around the second pulley 220 increases and the winding radius of the belt 230 around the first pulley 210 decreases. In this manner, the hydraulic pressure control device 240 changes the gear ratio in the automatic transmission 200.

The first control valve 247 and the second control valve 248 are each controlled by a signal hydraulic pressure. The modulator valve 242 regulates the line pressure PL to the signal hydraulic pressure. The oil adjusted to the signal hydraulic pressure is supplied to the first linear solenoid valve 243 and the second linear solenoid valve 244.

The first linear solenoid valve 243 controls the signal hydraulic pressure supplied to the first control valve 247. The second linear solenoid valve 244 controls the signal hydraulic pressure supplied to the second control valve 248. The signal hydraulic pressure supplied to the first control valve 247 is controlled by opening and closing the first linear solenoid valve 243. The signal hydraulic pressure supplied to the second control valve 248 is controlled by opening and closing the second linear solenoid valve 244.

The first hydraulic damper 245 is provided in an oil passage connecting the first linear solenoid valve 243 to the first control valve 247. The second hydraulic damper 246 is provided in an oil passage connecting the second linear solenoid valve 244 to the second control valve 248.

### Reference Cluster Data

Reference cluster data is stored in the storage 120 of the abnormality diagnosis system 100. The reference cluster data is data on a result obtained by classifying, into a predetermined number of clusters, data points on differential pressure at multiple time points included in the data on changes in differential pressure between the target hydraulic pressure and the hydraulic pressure that is obtained when the hydraulic pressure control device 240 in which the abnormality has not occurred is operated in the predetermined diagnosis pattern. To generate the reference cluster data, the hydraulic pressure is measured while operating the hydraulic pressure control device 240 in which the abnormality has not occurred in the predetermined diagnosis pattern. For example, the line pressure PL, the first hydraulic pressure Pp, and the second hydraulic pressure Ps among the hydraulic pressures at multiple parts in the hydraulic pressure control device 240 are measured.

FIG. 3 shows changes in a target hydraulic pressure Ppt of the first hydraulic pressure Pp in the predetermined diagnosis pattern. The predetermined diagnosis pattern is defined by a target hydraulic pressure PLt of the line pressure PL, the target hydraulic pressure Ppt of the first hydraulic pressure Pp, and a target hydraulic pressure Pst of the second hydraulic pressure Ps. The predetermined diagnosis pattern is defined such that the line pressure PL, the first hydraulic pressure Pp, and the second hydraulic pressure Ps are fluctuated over a predetermined period so as to diagnose an abnormality in each portion of the hydraulic pressure control device 240 from the changes in the measured hydraulic pressure. The target hydraulic pressure PLt of the line pressure PL, the target hydraulic pressure Ppt of the first hydraulic pressure Pp, and the target hydraulic pressure Pst of the second hydraulic pressure Ps in the predetermined diagnosis pattern have different fluctuation patterns.

The actual hydraulic pressure varies with a delay with respect to the fluctuation of the target hydraulic pressure. The actual hydraulic pressure may overshoot the target hydraulic pressure. Instead of immediately converging to the target hydraulic pressure, the actual hydraulic pressure may oscillate up and down across the target hydraulic pressure until it converges to the target hydraulic pressure. The data indicating the changes in differential pressure between the target hydraulic pressure and the measured hydraulic pressure includes information on the delay, overshoot, and oscillation of the actual hydraulic pressure with respect to the target hydraulic pressure. Such delay, overshoot, and oscillation occur even in the hydraulic pressure control device 240 in which no abnormality has occurred. The reference cluster data is generated through clustering, which is machine learning. As a clustering algorithm, for example, the k-means method is used. The k-means method is a clustering algorithm for classifying data points into a predetermined number of clusters. The clustering algorithm is not limited to the k-means method.

By performing the clustering, the data points at each time point included in the data indicating the changes in differential pressure can be classified into a cluster of data points having similar characteristics.

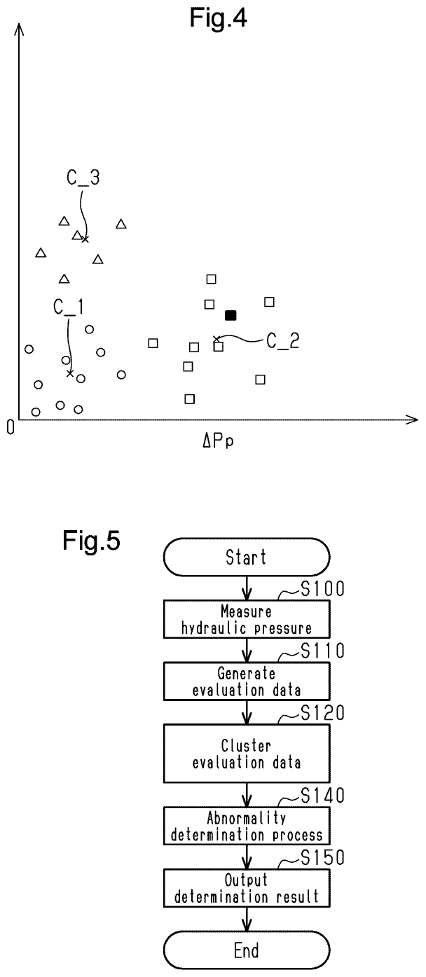

FIG. 4 is a graph showing an example in which the data points on the changes in differential pressure at multiple time points is clustered into three clusters by the k-means method using two explanatory variables included in the data points on the changes in differential pressure. In the example shown in FIG. 4, a differential pressure ΔPp of the first hydraulic pressure Pp and a differential pressure ΔPp of the second hydraulic pressure Ps are used as explanatory variables. In FIG. 4, each of the data points in differential pressure at multiple time points is indicated by a hollow symbol.

In FIG. 4, these data points in differential pressure are shown on a two-dimensional space with the differential pressure ΔPp and the differential pressure ΔPs as coordinate axes. FIG. 4 is an example in which data points on differential pressure at time points are clustered into three clusters. In FIG. 4, the coordinates of data points classified into the first cluster are indicated by hollow circles. In FIG. 4, the coordinates of data points classified into the second cluster are indicated by hollow squares. In FIG. 4, the coordinates of data points classified into the third cluster are indicated by hollow triangles. In FIG. 4, the centroid of each cluster is indicated by a cross mark. The centroid C_1 is the centroid of the first cluster. The centroid C_2 is the centroid of the second cluster. The centroid C_3 is the centroid of the third cluster.

The reference cluster data is data on the changes in differential pressure to which a label indicating the result of the clustering is attached. Specifically, the reference cluster data is generated by assigning a label for identifying a cluster into which the data is classified to each data point indicated by a hollow symbol in the coordinate space. The storage 120 of the abnormality diagnosis system 100 stores the reference cluster data generated in this manner.

The abnormality diagnosis system 100 executes an abnormality determination process using the reference cluster data stored in the storage 120.

### Series of Processes Executed by Abnormality Diagnosis System 100

The abnormality diagnosis system 100 performs diagnosis using data on the changes in hydraulic pressure when the hydraulic pressure control device 240 to be diagnosed is operated in the predetermined diagnosis pattern. The predetermined diagnosis pattern is the same diagnosis pattern as that when the hydraulic pressure control device 240 in which no abnormality has occurred is operated when the reference cluster data is generated.

The flow of processes for abnormality diagnosis executed by the abnormality diagnosis system 100 will now be described with reference to FIG. 5. The series of processes illustrated in FIG. 5 is executed by the processing circuitry 110 of the abnormality diagnosis system 100.

As shown in FIG. 5, first, in the process of step S100, the processing circuitry 110 measures the hydraulic pressure while operating the hydraulic pressure control device 240 in the predetermined diagnosis pattern. The processing circuitry 110 measures the line pressure PL, the first hydraulic pressure Pp, and the second hydraulic pressure Ps while operating the hydraulic pressure control device 240 in accordance with the predetermined diagnosis pattern, as in the case of creating the reference cluster data. The processing circuitry 110 records data on the measured hydraulic pressure in the storage 120.

In the process of step S110, the processing circuitry 110 generates, as evaluation data, data indicating the changes in differential pressure between the hydraulic pressure recorded in the storage 120 and the target oil pressure. The processing circuitry 110 records the generated evaluation data in the storage 120.

In the process of step S120, the processing circuitry 110 compares the evaluation data with the reference cluster data to cluster the evaluation data. Specifically, the processing circuitry 110 compares the data points on differential pressure at time points included in the evaluation data with the centroid of each cluster in the reference cluster data, and determines to which cluster the data points at the time points in the evaluation data belongs.

For example, the processing circuitry 110 calculates the distance between each differential pressure data point at multiple time points in the evaluation data and the centroids of each cluster. The processing circuitry 110 then determines that each data point belongs to the cluster with the closest centroid. The distance may be calculated using any distance calculation method, such as the Euclidean distance, Mahalanobis distance, or Manhattan distance. A calculation method suitable for diagnosis may be adopted.

In FIG. 4, the coordinates of one data point among the differential pressure data at time points in the evaluation data are indicated by a black square symbol. In the example shown in FIG. 4, the centroid closest to the coordinates of this data point is the centroid C_2. Thus, in this example, the processing circuitry 110 determines that this data point belongs to the second cluster. If a data point in differential pressure greatly deviates from the centroid of any cluster, the processing circuitry 110 determines that the data point does not belong to any cluster. In this manner, the processing circuitry 110 determines to which cluster each of the data points of the differential pressures at the time points included in evaluation data belongs. The processing circuitry 110 generates cluster evaluation data by adding, to each of the data points of the differential pressures at the time points included in evaluation data, a label for identifying a cluster into which the data is classified. In this manner, the data obtained by assigning a label to the data on the changes in differential pressure for the hydraulic pressure control device 240 to be diagnosed is the evaluation cluster data. The processing circuitry 110 stores, in the storage 120, the evaluation cluster data, which is the result of comparison with the reference cluster data.

In the process of step S140, the processing circuitry 110 executes an abnormality determination process. In the abnormality determination process, the processing circuitry 110 determines that an abnormality has occurred in the hydraulic pressure control device 240 based on the fact that the cluster determination results of the reference cluster data and the evaluation cluster data deviate from each other.

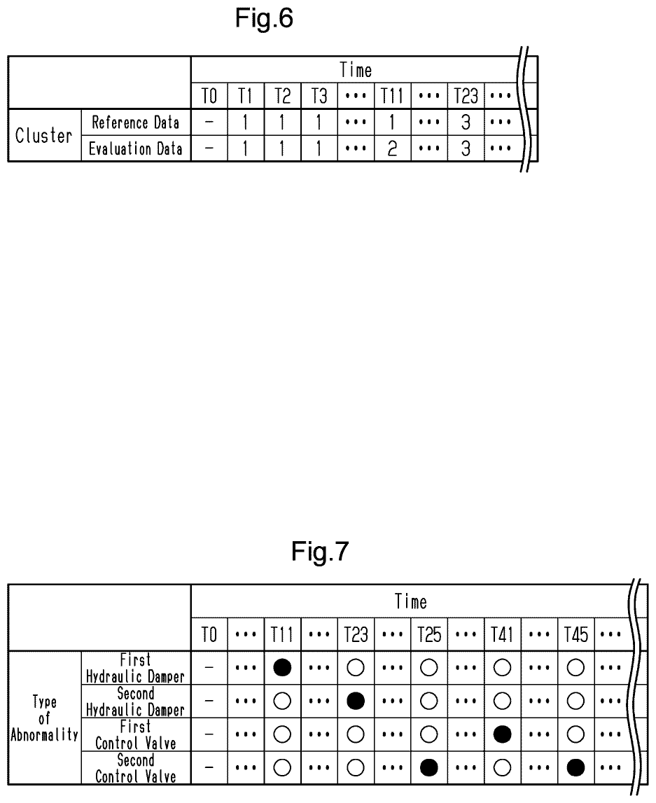

Specifically, the processing circuitry 110 compares the reference cluster data with the evaluation cluster data. As shown in FIG. 6, the processing circuitry 110 compares the label assigned to the data point on each time point in the evaluation cluster data with the label assigned to the data point on each time point in the reference cluster data. In FIG. 6, the information of the label in the reference cluster data is displayed in the column of “reference data”, and the information of the label in the evaluation cluster data is displayed in the column of “evaluation data”. In this comparison, the labels corresponding to the same time point are compared with each other. Then, the processing circuitry 110 identifies a portion where the label assigned to the evaluation cluster data does not match the label assigned to the reference cluster data. In FIG. 6, the label of the first cluster is indicated as 1, the label of the second cluster is indicated as 2, and the label of the third cluster is indicated as 3. In FIG. 6, the label is indicated by “-” when the cluster is not any cluster.

In the example of FIG. 6, the labels at the time point T11 do not match. The processing circuitry 110 stores and records the comparison result in the storage 120. Then, the processing circuitry 110 identifies the location where an abnormality has occurred according to the time point at which the labels did not match.

In a case where an abnormality has occurred in the hydraulic pressure control device 240, the changes in the fluctuation of the hydraulic pressure when the hydraulic pressure control device 200 is operated in the predetermined diagnosis pattern deviates from the changes in the fluctuation in a case where no abnormality has occurred. Therefore, the label in the evaluation cluster data, which is the result of clustering, is also different from the label in the reference cluster data.

As described above, the predetermined diagnosis pattern is defined such that the line pressure PL, the first hydraulic pressure Pp, and the second hydraulic pressure Ps are fluctuated over the predetermined period so as to diagnose an abnormality in each portion of the hydraulic pressure control device 240 from the changes in the measured hydraulic pressure. That is, the predetermined diagnosis pattern is defined so as to diagnose which portion is abnormal based on the information on the time point at which a difference occurs between the label in the evaluation cluster data and the label in the reference cluster data.

For example, in a case in which an abnormality has occurred in the first hydraulic damper 245, the label in the reference cluster data and the label in the evaluation cluster data do not match at the time point T11.

FIG. 7 shows, for each type of abnormality, at which time point the label in the reference cluster data and the label in the evaluation cluster data do not match. In FIG. 7, a blank circle is displayed at the time point when the label in the reference cluster data and the label in the evaluation cluster data match. A black circle is displayed at the time point when the label in the reference cluster data and the label in the evaluation cluster data do not match. Information for diagnosing the type of abnormality is stored in the storage 120 of the abnormality diagnosis system 100.

The example of FIG. 7 indicates that, in a case in which an abnormality has occurred in the second hydraulic damper 246, the label in the reference cluster data and the label in the evaluation cluster data do not match each other at the time point T23. The example of FIG. 7 indicates that, in a case in which an abnormality has occurred in the first control valve 247, the label in the reference cluster data and the label in the evaluation cluster data do not match each other at the time point T41. The example of FIG. 7 indicates that, in a case in which an abnormality has occurred in the second control valve 248, the label in the reference cluster data and the label in the evaluation cluster data do not match each other at the time point T25 and the time point T45.

In a case where no abnormality has occurred in the hydraulic pressure control device 240 to be diagnosed, the changes in the fluctuation of the hydraulic pressure when the hydraulic pressure control device 200 is operated in the predetermined diagnosis pattern are not greatly different from the changes in the fluctuation when the reference cluster data is generated. Thus, the label in the evaluation cluster data, which is the result of clustering, matches the label in the reference cluster data. Therefore, in a case where no abnormality has occurred in any part, the label in the reference cluster data and the label in the evaluation cluster data match each other at any time.

The information shown in FIG. 7 is stored in the storage 120 as information for diagnosing the type of abnormality described above. The processing circuitry 110 diagnoses whether an abnormality has occurred and diagnoses the type of abnormality with reference to the information stored in the storage 120 in the abnormality determination processing in step S140.

In the process of step S150, the processing circuitry 110 outputs the determination result diagnosed through the abnormality determination process. Specifically, the processing circuitry 110 displays the determination result on the display 130.

### Operation of Present Embodiment

The processing circuitry 110 of the abnormality diagnosis system 100 generates, as evaluation data, data points indicating the changes in the differential pressure of the hydraulic pressure control device 240 to be evaluated (step S110). The processing circuitry 110 determines to which cluster in the reference cluster data each data point in the evaluation data belongs to generate evaluation cluster data (step S120). The processing circuitry 110 determines that an abnormality has occurred in the hydraulic pressure control device 240 based on the fact that the determination results of the clusters deviate from each other (step S140).

When an abnormality occurs in the hydraulic pressure control device 240, the hydraulic pressure deviates from the target hydraulic pressure. Therefore, a shift corresponding to whether an abnormality has occurred in the data points on the changes in differential pressure between the hydraulic pressure obtained when the hydraulic pressure control device 240 is operated in the predetermined diagnosis pattern and the target hydraulic pressure. The abnormality diagnosis system 100 compares the reference cluster data with the evaluation cluster data. Then, the abnormality diagnosis system 100 determines whether an abnormality has occurred in the hydraulic pressure control device 240 based on the fact that the determination results of the clusters of the reference cluster data and the evaluation cluster data deviate from each other.

### Advantages of Present Embodiment

(1) The abnormality diagnosis system 100 performs a determination using the data on the fluctuation of the hydraulic pressure of the hydraulic pressure control device 240. This allows the abnormality diagnosis system 100 to acquire changes in the behavior of a hydraulic pressure resulting from an abnormality and determine that an abnormality has occurred in the hydraulic pressure control device 240.

(2) The predetermined diagnosis pattern divides a time into periods according to types of abnormalities to be determined, and controls hydraulic pressures at multiple parts controlled by the hydraulic pressure control device 240 in order in a pattern in which each of the abnormalities is readily determined. The processing circuitry 110 of the abnormality diagnosis system 100 is configured to determine the types of abnormalities that have occurred in the hydraulic pressure control device 240 based on the information on the period in which the reference cluster data and the evaluation cluster data deviate from each other.

The abnormality diagnosis system 100 controls hydraulic pressures at multiple parts in accordance with a diagnosis pattern so that each abnormality can be readily determined. Thus, when the period in which the reference cluster data and the evaluation cluster data deviate from each other is recognized, it is possible to determine that an abnormality corresponding to the period has occurred. The abnormality diagnosis system 100 determines the types of abnormalities that have occurred in the hydraulic pressure control device 240 based on the information on the period indicating the reference cluster data and the evaluation cluster data deviate from each other. The abnormality diagnosis system 100 determines the type of an abnormality that has occurred.

### MODIFICATIONS

The present embodiment may be modified as follows. The present embodiment and the following modifications can be combined as long as they remain technically consistent with each other.

The abnormality diagnosis system 100 does not have to determine the type of abnormality. For example, the presence or absence of abnormality and the information of the label at each time point illustrated in FIG. 7 are output.

That is, in the same manner as the above-described embodiment, the predetermined diagnosis pattern divides a time into periods according to types of abnormalities to be determined, and controls hydraulic pressures at multiple parts controlled by the hydraulic pressure control device 240 in order in a pattern in which each of the abnormalities is readily determined.

The processing circuitry 110 is configured to output information indicating a period in which the reference cluster data and the evaluation cluster data deviate from each other, together with the information on a determination result as to whether an abnormality has occurred in the hydraulic pressure control device 240. This allows the abnormality diagnosis system 100 to provide information serving as a material for determining not only whether an abnormality has occurred but also the type of abnormality that has occurred.

The above-described abnormality diagnosis system 100 is configured to determine whether an abnormality has occurred in the hydraulic pressure control device 240, which controls a hydraulic pressure supplied to the first pulley 210 and the second pulley 220 in a continuously variable transmission. The hydraulic pressure control device 240 to be diagnosed is not limited to the hydraulic pressure control device 240 of the continuously variable transmission. The diagnosis target may be a hydraulic pressure control device of a stepped transmission. The diagnosis target is not limited to the hydraulic pressure control device of the automatic transmission.

In the above-described embodiment, the abnormality diagnosis system 100 includes the processing circuitry 110 and the storage 120, and executes software processing. However, this is merely exemplary. For example, the abnormality diagnosis system 100 may include a dedicated hardware circuit (such as ASIC) that executes at least part of the software processes executed in the above-described embodiment. That is, the abnormality diagnosis system 100 may have any one of the following configurations (A) to (C). (A) The abnormality diagnosis system 100 includes an execution device that executes all the processes in accordance with a program and a storage that stores the program. That is, the abnormality diagnosis system 100 includes a software execution device. (B) The abnormality diagnosis system 100 includes an execution device that executes some of the processes in accordance with a program, and a storage. Further, the abnormality diagnosis system 100 includes a dedicated hardware circuit that performs the remaining processes. (C) The abnormality diagnosis system 100 includes a dedicated hardware circuit that executes all the processes. There may be multiple software execution devices and/or dedicated hardware circuits. That is, the above processes may be executed by processing circuitry that includes at least one of a set of one or more software execution devices and a set of one or more dedicated hardware circuits. The storage (i.e., computer-readable medium) that stores a program includes any type of media that are accessible by general-purpose computers and dedicated computers.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An abnormality diagnosis system for a hydraulic pressure control device, the abnormality diagnosis system comprising:
processing circuitry; and
a storage, wherein
the storage stores reference cluster data, the reference cluster data being obtained by classifying, into a predetermined number of clusters by clustering, data points on differential pressure at multiple time points included in data on changes in differential pressure between a target hydraulic pressure and a hydraulic pressure that is obtained when a hydraulic pressure control device in which an abnormality has not occurred is operated in a predetermined diagnosis pattern, and the clustering being machine learning, and
the processing circuitry is configured to:
generate, as evaluation data, data indicating changes in differential pressure between the target hydraulic pressure and a hydraulic pressure that is recorded while operating the hydraulic pressure control device to be evaluated in the diagnosis pattern;
generate evaluation cluster data obtained by determining which of the predetermined number of clusters in the reference cluster data each of data points at multiple time points in the evaluation data belongs to by comparing data points on differential pressure at multiple time points included in the evaluation data with a centroid of each of the clusters in the reference cluster data; and
determine that an abnormality has occurred in the hydraulic pressure control device based on a deviation of a determination result of the clusters between the reference cluster data and the evaluation cluster data.

2. The abnormality diagnosis system according to claim 1, wherein
the diagnosis pattern divides a time into periods according to types of abnormalities to be determined, and control hydraulic pressures at multiple parts controlled by the hydraulic pressure control device in order in a pattern in which each of the abnormalities is readily determined; and
the processing circuitry is configured to output information indicating a period in which the reference cluster data and the evaluation cluster data deviate from each other, together with information on a determination result as to whether an abnormality has occurred in the hydraulic pressure control device.

3. The abnormality diagnosis system according to claim 1, wherein
the diagnosis pattern divides a time into periods according to types of abnormalities to be determined, and control hydraulic pressures at multiple parts controlled by the hydraulic pressure control device in order in a pattern in which each of the abnormalities is readily determined; and
the processing circuitry is configured to determine a type of abnormality that has occurred in the hydraulic pressure control device based on information on a period in which the reference cluster data and the evaluation cluster data deviate from each other.

4. An abnormality diagnosis system, wherein
the abnormality diagnosis system according to claim 1 is configured to determine whether an abnormality has occurred in a hydraulic pressure control device that controls a hydraulic pressure supplied to a first pulley and a second pulley in a continuously variable transmission.

5. The abnormality diagnosis system according to claim 4, wherein
the diagnosis pattern divides a time into periods according to types of abnormalities to be determined, and control hydraulic pressures at multiple parts controlled by the hydraulic pressure control device in order in a pattern in which each of the abnormalities is readily determined; and
the hydraulic pressures at the parts controlled by the hydraulic pressure control device include a first hydraulic pressure and a second hydraulic pressure, the first hydraulic pressure being a hydraulic pressure at the first pulley, and the second hydraulic pressure being a hydraulic pressure at the second pulley.
